(19) United States
(12) Patent Application Publication
(10) Pub. No.: US 2013/0007986 A1
(43) Pub. Date: Jan. 10, 2013

(54) DOOR HINGE

(76) Inventors: Kyle Flaman, White City (CA); John Kletchko, Regina (CA); Greg Kletchko, St. Joseph's Colony (CA)

(21) Appl. No.: 13/492,161

(22) Filed: Jun. 8, 2012

(30) Foreign Application Priority Data
Jun. 8, 2011 (CA) 2742422

(51) Int. Cl. E05D 5/04; E05D 3/00

(52) U.S. Cl. 16/387

(57) ABSTRACT

A butt hinge including a first leaf having a top surface and a second leaf having a top surface. A protrusion is provided on one of the top surface of the first leaf and the top surface of the second leaf and an aperture passes through another of the top surface of the first leaf and the top surface of the second leaf. The aperture is positioned in the other of the top surface of the first leaf and the top surface of the second leaf so that when the butt hinge is used to hang a door, the protrusion is inserted into the aperture when the door is closed.

The present invention relates to door hinges and more particularly to a door hinge that can be used to easily remove a door but still remain secure when the door is closed.

### BACKGROUND

Doors are connected to a door frame by hinges. These hinges allow the door to be opened and closed and typically consist of two leaves attached to cylindrical bosses. The cylindrical bosses are spaced on each leaf so that they can be interleaved causing the bosses of both leaves to be positioned coaxial, allowing a pin or pintle to be inserted through the bosses, hingeably joining the door to the door frame.

To remove the door from the door frame and separate the hinge, a user can open the door and remove the pin or pintle running through the bosses. With the pin or pintle removed, the door can then be removed from the door frame, with the leaves of the hinges attached to the door being separated from the leaves of the hinges that are attached to the door frame.

While this allows the door to be removed from the frame, it does not typically allow it to be removed without some effort. A person has to remove the pin or pintle from the door hinges, which can often require tools and some effort to force the pin or pintle out of the bosses. In some cases, the pin or pintle can be secured in the hinge by more than gravity and force, requiring a person to first use tools to partially dissemble the pin or pintle and remove it from the hinge.

On the other hand, some hinges have been made that allow easy removal of the door. However, these often suffer from the problem of making it to easy for a person to remove a door which can result in security issues, such as having a person remove a door from the hinges of a building when he or she wishes to gain unlawful entry into the building.

### SUMMARY OF THE INVENTION

In one aspect, a butt hinge is provided. The butt hinge can comprise: a first leaf having a top surface and at least one ear with a pin extending from the ear; a second leaf having a top surface and at least one barrel with a passage therethrough, the second leaf positioned on the second leaf to line up so as to line up with the pin on the at least one ear of the first leaf; a protrusion on one of the top surface of the first leaf and the top surface of the second leaf; and an aperture passing through an other of the top surface of the first leaf and the top surface of the second leaf, the aperture positioned in the other of the top surface of the first leaf and the top surface of the second leaf so that when the butt hinge is used to hang a door, the protrusion is inserted into the aperture when the door is closed.

### DESCRIPTION OF THE DRAWINGS

A preferred embodiment of the present invention is described below with reference to the accompanying drawings, in which:

FIG. 1 illustrates a front view of a butt hinge with the first leaf and second leaf separated;

FIG. 2 illustrates a top view of the hinge of FIG. 1;

FIG. 3 illustrates a front view of the hinge of FIG. 1 with the leaves connected;

FIG. 4 illustrates a door and door frame attached with the hinge of FIG. 1 with the door in the open position;

FIG. 5 illustrates the door and door frame of FIG. 4 with the door in the closed position;

FIG. 6 illustrates a butt hinge in a further aspect; and

FIG. 7 illustrates a butt hinge in a further aspect.

### DETAILED DESCRIPTION OF THE ILLUSTRATED EMBODIMENTS

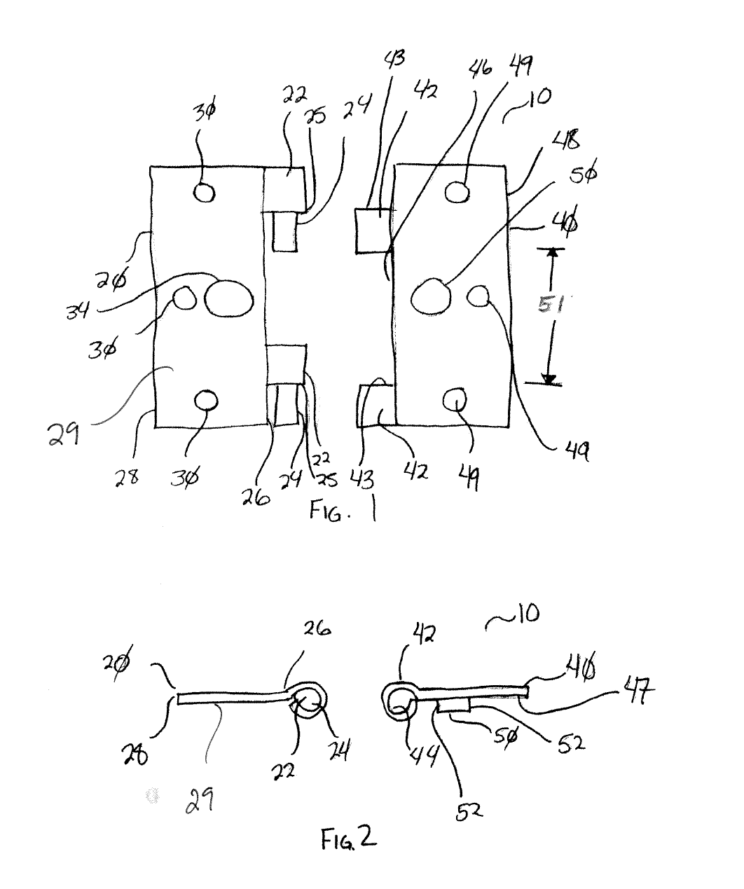

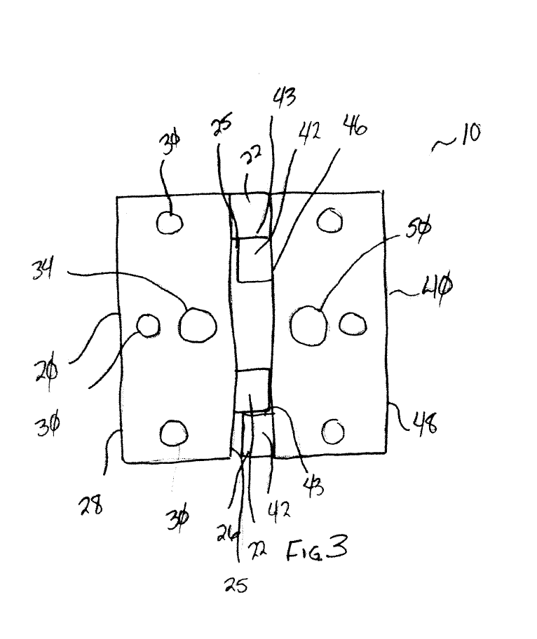

FIGS. 1-3 illustrate a butt hinge 10 in one aspect. Butt hinges 10 can be used to join a door to a door frame (not shown) in such a way that when the door is opened, the hinges 10 allow the door to be relatively quickly removed by simply lifting up on the door. However, when the door is closed in the door frame, the hinges 10 prevent the door from being removed from the frame.

The hinge 10 can have a first leaf 20 and a second leaf 40 with the first leaf 20 having one or more pins 24 and the second leaf 40 having one or more barrels 42 for receiving the pins 24.

The first leaf 20 can have a first side 26 and a second side 28 with one or more ears 22 provided on the first side 26 of the first leaf 20. Each ear 22 can have a pin 24 extending below the ear 22. A number of mounting apertures 30 can be provide passing through the first leaf 20 so screws or other fasteners (not shown) can be used to fasten the first leaf 20 to an edge of a door that will be hung using the hinge 10.

The second leaf 40 can have a first side 46 and a second side 48 with one or more barrels 42 provided on the first side 46 of the second leaf 40. Each barrel 42 can have a passage 44 running through the barrel 42 and sized to accept one of the pins 24 extending from the ear 22 on the first leaf 20. The ears 22 and pins 24 can be spaced on the first leaf 20 so that the ears 22 and pins 24 can be lined up and inserted into the passages 44 in the barrels 42 on the second leaf 40. The second leaf 40 can have a series of mounting apertures 49 so screws or other fasteners (not shown) can be used to fasten the second leaf 40 to a door frame (not shown).

In one aspect, the ear 22 can be sized so that a bottom edge 25 of the ear 22 can rest against a top edge 43 of the barrel 42 when the pin 24 extending from the ear 22 is inserted in the passage 44 of the barrel 42. A spacing 51 can be provided between the barrels 42 on the second leaf 40 so that lower ear 22 and pin 24 on the first leaf 20 can be slid in the spacing 51 between the barrels 42, while the upper ear 22 and pin 24 can be positioned above the top barrel 42 on the second leaf 40. Then, the first leaf 20 can be moved downwards relative to the second leaf 40, sliding the pins 24 into the passages 44 in the barrels 42 on the second leaf 40, as shown in FIG. 3.

An aperture 34 can be provided in the first leaf 20 and a protrusion 50 can be provided on the second leaf 40. The aperture 34 can be positioned on the first leaf 20 and the protrusion 50 can be provided on the second leaf 40 so that when the first leaf 20 and the second leaf 40 are rotated around the ears 22, pins 24 and barrels 44 and against one another, the protrusion 50 is inserted in the aperture 34.

In one aspect the protrusion 50 can be circular in shape and in one aspect have straight sides 52 extending substantially perpendicular from a top surface 47 of the second leaf 40.

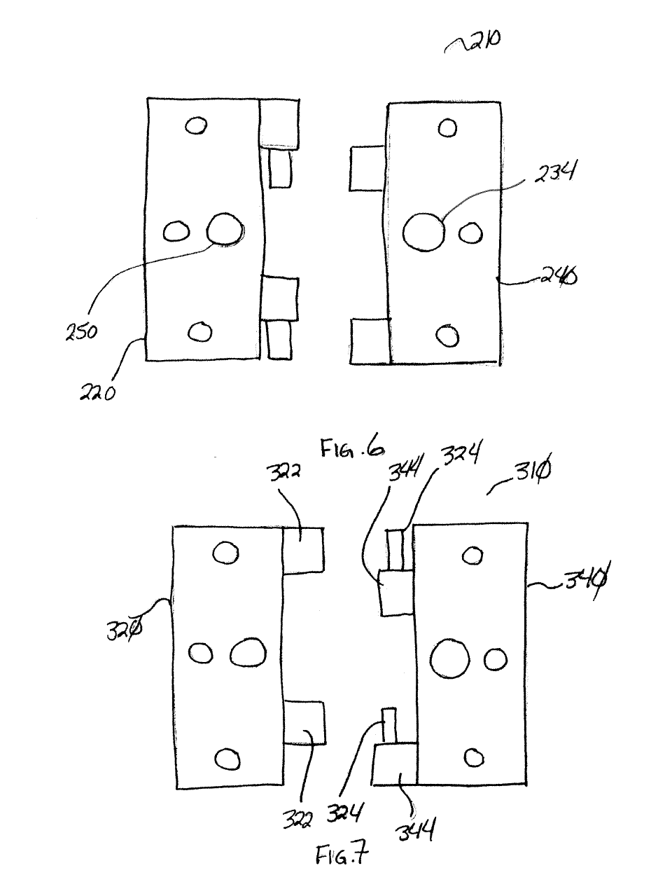

FIG. 6 shows an alternate butt hinge 210 where a protrusion 250 is provided on the first leaf 220 and a mating aperture 234 is provided on the second leaf 240.

FIG. 7 shows an alternate butt hinge 310 with the first leaf 320 for attaching to a door (not shown) having barrels 322 while the second leaf 340 that is attached to a door jamb (not shown) has ears 344 and pins 324 extending upwards from the ears 344. The first leaf 320 can be attached to the second leaf 340 by sliding the barrels 322 on the first leaf 320 over the pins 324 on the second leaf 340.

Referring to FIG. 1-5, in operation the first leaf 20 can be attached to a door 100, typically by placing screws or other fasteners through the mounting apertures 30 in the first leaf 20 to secure the first leaf 20 to an edge 110 of the door 100. The second leaf 40 can be attached to a door jamb 160 of a door frame 150, typically by placing screws or other fasteners through the mounting apertures 49 in the second leaf 40. The first leaf 20 and the second leaf 40 have to positioned on the door 100 and door jamb 160, respectively, so that the first leaf 20 and second leaf 40 will be aligned when the door 100 is hung by the door hinges 10.

To hang the door 100 in the door frame 150, the door 10 can be placed in an open position and the pins 24 on the first leaf 20 positioned above the barrels 42 on the second leaf 40. The door 100 can then be moved downwards so that the pins 24 on the ears 22 of the first leaves 20 slide into the passages 44 of the barrels 42 on the second leaves 40. The door 100 can then be opened and closed by swinging it on the door hinges 10.

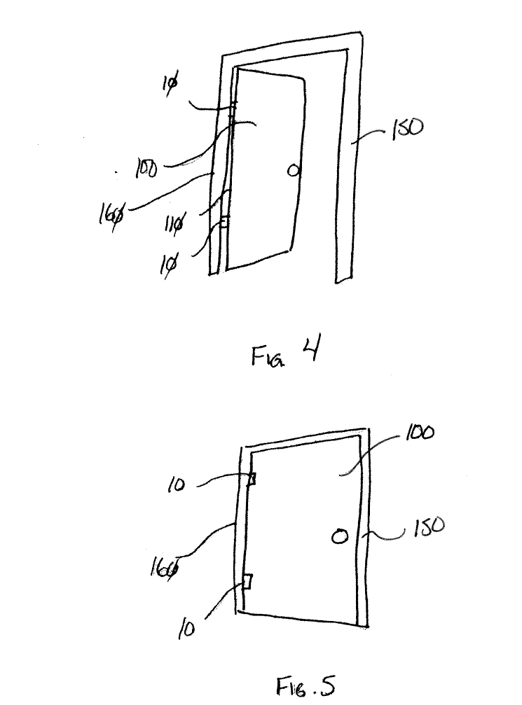

The door 100 can easily be removed by a single person by having that person simply open the door 100, as shown in FIG. 4, and lifting the door 100 so that the pins 24 of the first leaves 20 are retracted from the barrels 44 on the second leaves 40. In this manner, the door 100 can be quickly removed without the use of tools. However, when the door 100 is in the closed positioned, as shown in FIG. 5, with the first leaves 20 lying adjacent to the second leaves 40 so that top surfaces 29 of the first leaves 20 are lying adjacent the top surfaces 47 of the second leaves 40, the protrusions 50 on the second leaves 40 extend through the top surfaces 29 of the first leaves 20 into the apertures 34 in the first leaves 20.

In this manner, the protrusions 50 hold the second leaves 40 fixed vertically relative to the first leaves 20, preventing the first leaves 20 from being moved upwards relative to the second leaves 40 and preventing the pins 24 from being lifted out of the barrels 44 on the second leaves 40 while the door 100 is closed.

The door hinge 10 therefore allows a person to easily remove a door 10 by opening the door 100 and lifting the door 100 to remove the pins 24 on the first leaves 20 attached to the door 100 from the barrels 44 of the second leaves 40 attached to the door jamb 160. However, when the door 100 is closed, the protrusions 50 prevent a person from lifting the door upwards.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A butt hinge for a hinge comprising:
a first leaf having a top surface and at least one ear with a pin extending from the ear;
a second leaf having a top surface and at least one barrel with a passage therethrough, the second leaf positioned on the second leaf to line up so as to line up with the pin on the at least one ear of the first leaf;
a protrusion on one of the top surface of the first leaf and the top surface of the second leaf; and
an aperture passing through an other of the top surface of the first leaf and the top surface of the second leaf, the aperture positioned in the other of the top surface of the first leaf and the top surface of the second leaf so that when the butt hinge is used to hang a door, the protrusion is inserted into the aperture when the door is closed.

2. The butt hinge of claim 1 wherein the top surface of the first leaf lies adjacent to the top surface of the second leaf when the door is closed.

3. The butt hinge of claim 1 wherein the protrusion is circular.

4. The butt hinge of claim 1 wherein the protrusion has straight sides extending substantially perpendicular from at least one of the top surface of the first leaf and a top surface of a second leaf.

5. The butt hinge of claim 1 wherein there are two barrels on the second leaf defining a spacing therebetween.

6. The butt hinge of claim 5 wherein the spacing is sized to allow the ear and pin on the first leaf to be inserted in the spacing.
